(19) United States
(12) Patent Application Publication
(10) Pub. No.: US 2012/0285059 A1
(43) Pub. Date: Nov. 15, 2012

(54) TALKING BALLOON

(76) Inventor: GREGORY EMERSON FISK, Provo, UT (US)

(21) Appl. No.: 13/106,428

(22) Filed: May 12, 2011

(51) Int. Cl. G09F 3/18

(52) U.S. Cl. 40/661.01; 40/642.02

(57) ABSTRACT

A talking balloon that may be easily attached to a toy or other display item to provide the toy with the appearance of saying customized words and thoughts. The talking balloon includes a board, a wire attached to the board, a fastener mechanism secured to the wire, the fastener mechanism is adapted to be secured to a toy.

### BACKGROUND OF THE INVENTION

This invention generally relates to a sign for displaying a message. More particularly, the present invention relates to a word/thought balloon for displaying a customizable message that is easy to attach to a toy, or collectible display figures, statuettes, etc.

Talking toys use voice actors, voice recorders, electronic voice chips, or complex audio devices to provide the talking toys with personalized messages. Talking toys also require expensive batteries that must be constantly replaced. Unfortunately, the known talking toys require voice recording devices that are complicated and expensive, which increases the production costs. Electronic talking toys have a pre-set, limited number of messages. In addition, different versions must also be recorded in many languages, depending on the country in which the talking toys are sold.

As can be seen, there is a need for providing a personalized message for toys that is easy and inexpensive to produce, reusable, customizable, and require no batteries.

### SUMMARY OF THE INVENTION

In one aspect of the present invention, a talking balloon includes a board, a wire attached to the board, a fastener mechanism secured to the wire, the fastener mechanism is adapted to be secured to a toy.

These and other features, aspects and advantages of the present invention will become better understood with reference to the following drawings, description and claims.

### BRIEF DESCRIPTION OF THE DRAWINGS

FIG. 1 illustrates a front perspective view of a talking word balloon (hereafter referred to as a ‘talking’ balloon) according to an exemplary embodiment of the present invention showing the talking balloon in use;

FIG. 2 illustrates a rear perspective view of the talking balloon of FIG. 1;

FIG. 3 illustrates a perspective front view of the talking balloon of FIG. 1;

FIG. 4 illustrates a rear view of the talking balloon of FIG. 3;

FIG. 5 illustrates a side view of the talking balloon of FIG. 3;

FIG. 6 illustrates a cross-section view of the talking balloon taken along line 6-6 in FIG. 3;

FIG. 7 illustrates a rear view of the talking balloon according to another exemplary embodiment of the present invention;

FIG. 8 illustrates a front view of the talking balloon of FIG. 7;

FIG. 9 illustrates a perspective front view of the talking balloon according to another exemplary embodiment of the present invention;

FIG. 10 illustrates a perspective rear view of the talking balloon according to another exemplary embodiment of the present invention;

FIG. 11 illustrates a section view of the talking balloon according to another exemplary embodiment of the present invention;

FIG. 12 illustrates a section view of the talking balloon according to another exemplary embodiment of the present invention taken along line 12-12 in FIG. 5 showing a sheath.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a talking balloon that may be easily attached to a toy to provide the toy with the appearance of saying customized words and thoughts.

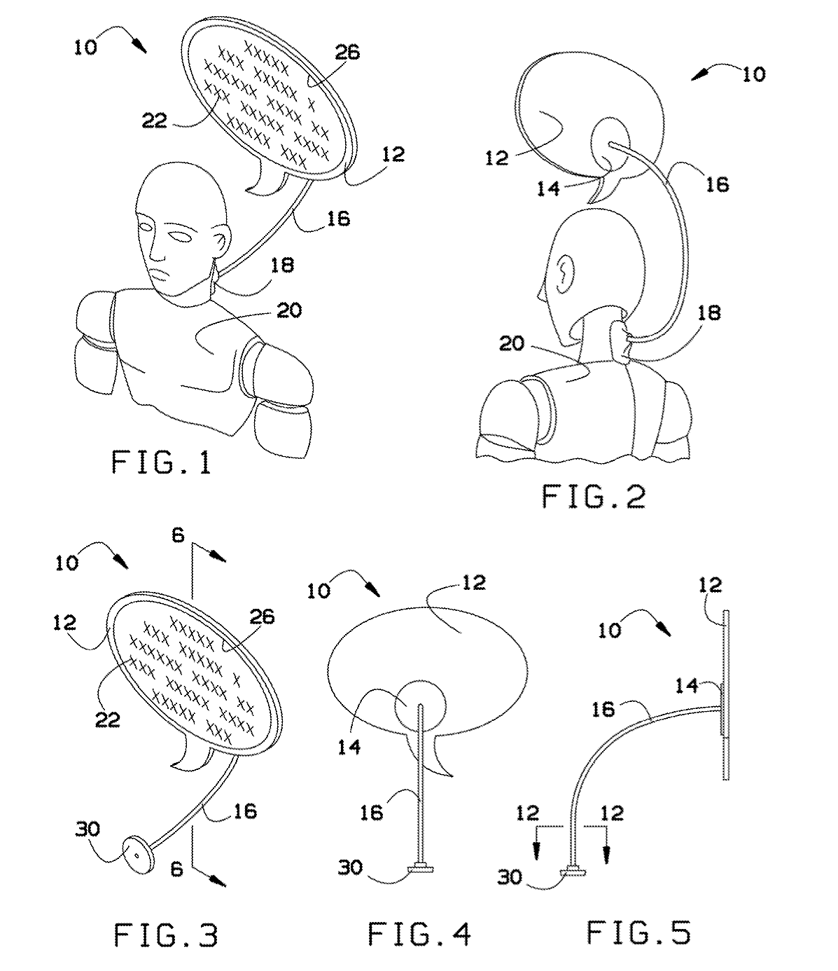

FIGS. 1-5 illustrate a talking balloon 10 according to an exemplary embodiment of the present invention. The talking balloon 10 may be adapted to be placed on a toy 20. The talking balloon 10 allows the user to provide the toy 20 with words and thoughts. The toy 20 may be an action figure, display figurines, statuettes, dolls, toy vehicles, stuffed animals, photographs, posters, a wall decoration, or pictures.

The talking balloon 10 may include a board 12, a wire 16 attached to the board 12, and fastener mechanism 30 secured to an end of the wire 16.

The fastener mechanism 30 may be adapted to secure the talking balloon 10 to the toy 20. FIGS. 1-2 show that the metal base 30 may be attached to the toy 20 by using a malleable and mildly adhesive putty 18. The putty 18 may be fitted around the metal base 30 to increase its surface area and holding properties.

The board 12 may be made of a flat and thin sturdy material. The board 12 may be made of plastic, wood, polymer, composite, or metal. The board 12 may be shaped in the form of a talking balloon. The talking balloon may be cloud-shaped, thereby making it a ‘thought balloon’, having at least one spur, or protruding edge, that extends outwardly towards the toy 20 to which it is directed. The board 12 may include a black outline 26 around the edges to provide the talking balloon 10 with the appearance of a comic book talking balloon. The size of the board 12 may depend on the size of the toy 20. In some embodiments, the size of the board 12 may be approximately 2½ inches wide and 2 inches tall. The board 12 may be made using various colors for display purposes. In some embodiments, the board 12 may be white since that is the traditional color of a word or thought balloon. In some embodiments, the board 12 may have different balloon and/or cloud shapes.

An individual blank sticker 26 may be placed against the front face of the board 12. The blank sticker 26 may allow the user to write a sentence, word, phrase, or message. The user may use a pen, pencil, or marker to write on the blank sticker. The blank sticker 26 may be sold in packages containing a plurality of blank stickers 26. In some embodiments, the blank sticker 26 may contain several sheets of paper that may be manually removed or peeled from the blank sticker 26 to expose the next layer. The blank sticker 26 may be removed and replaced with a fresh blank sticker so that text may be changed, and a new text added at any time by the user. This feature may allow the talking balloon 10 to be customizable. The shape of the blank sticker 26 may be the same as the shape of the board 12. The blank stickers 26 may also be of various colors for display purposes and/or to match any color used for the board 12. In some embodiments, the blank sticker 26 may be white, to match the traditional color of a word or thought balloon, thereby blending to the board 12 without any visible edges or seams.

FIGS. 1 and 3 may illustrate the blank stickers 26 with custom text 22. The sticker 26 may be blank and the user may write a desired text 22 directly on them. In some embodiments, the blank sticker 26 may include pre-printed phrases, topical phrases, or slang phrases.

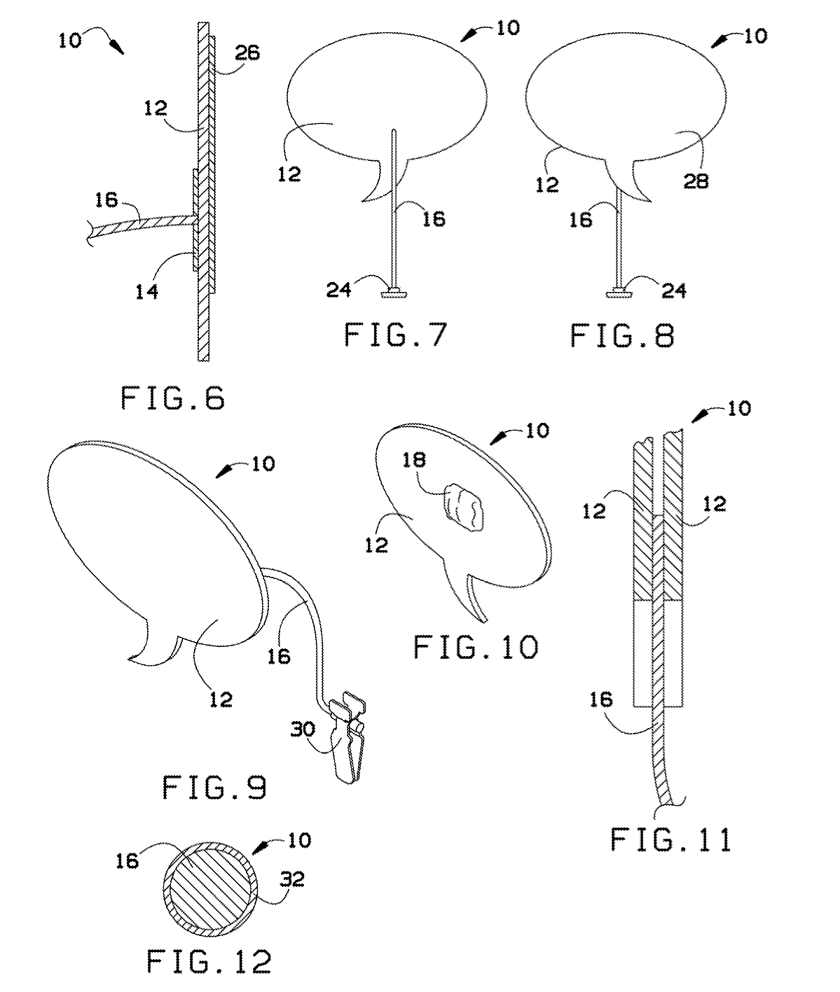

FIGS. 2, 4, and 5-6 illustrate that a disc 14 may be placed or adhered at one end of the flexible wire 16 to help in securing the wire 16 to the board 12. The disc 14 may be glued, welded, or adhered to the board 12. The disc 14 may be made of metal or plastic. The diameter of the disc 14 may depend on the size of the toy 20 and/or the board 12. In some embodiments, the disc 14 may be a diameter of 2 cm.

The fastener mechanism 30 may allow the user to secure the talking balloon 10 to the toy 20. The fastener mechanism 30 may be a clip, a hook and loop fastener, a disc having an adhesive layer 24, a clasp, a suction cup, a clamp, or a magnet.

FIGS. 7-8 illustrate an alternate embodiment of the present invention on which the fastener mechanism 30 is a disc 24 having an adhesive layer to directly attach the talking balloon 10 to the toy 20. In addition, FIGS. 7-8 show that the wire 16 may be connected, welded, or adhered directly to the board 12.

In addition, FIG. 8 illustrates that the board 12 may include a writable/erasable surface 28 to allow the user to write and erase the messages directly onto the board 12 by using an erasable pen or marker.

FIG. 9 illustrates an alternate embodiment of the present invention on which the fastener mechanism 30 may be a clip.

FIG. 10 shows that an alternate embodiment of the talking balloon 10 of the present invention on which a mildly adhesive putty material 18 may be placed on the back of the board 12 to secure the talking balloon 10 directly to the toy 20, or onto flat surface display areas such as photographs, wall posters and so on.

FIG. 11 illustrates that the talking balloon 10 may include two opposite facing boards 12 secured with the wire 16 welded, glued or adhered between them.

The wire 16 may serve as a support to the board 12. The wire 16 may be made of a flexible but sturdy material. The wire may be made of metal, which can be aluminum, steel, copper, iron or alloys. The wire 16 may be made of a transparent material. The wire 16 may be gently bent and shaped to level the talking balloon 10 with the toy 20. The length and diameter of the wire 16 may depend on the size of the toy 20. In some embodiments, the wire 16 may be approximately 3 inches long.

As can be seen on FIG. 12, the wire 16 may include a rubber or plastic cover/sheath 32 to protect the wire 16 from decaying. In addition, the cover/sheath 32 may provide the wire 16 with additional structural support. The cover/sheath 32 may be of different colors to minimize its visibility or to match any colors used for the board 12 and the blank sticker 26.

It should be understood, of course, that the foregoing relates to exemplary embodiments of the invention and that modifications may be made without departing from the spirit and scope of the invention as set forth in the following claims.

1. A talking balloon comprising: a board; a wire having a first end attached to the board; a fastener mechanism secured to a second end of the wire; a malleable adhesive putty adhered to the fastener mechanism; wherein the fastener mechanism is adapted to be secured to a toy or a display item through the use of the malleable adhesive putty.

2. The talking balloon according to claim 1, further including a blank sticker attached to the board.

3. The talking balloon according to claim 1, wherein the board has a shape resembling a cloud sphere having at least one protruding edge that extends outwardly.

4. The talking balloon according to claim 2, wherein the blank sticker includes several removable layers of paper to allow a user to rewrite and change messages.

5. The talking balloon according to claim 1, wherein the wire is made of flexible and bendable material.

6. The talking balloon according to claim 1, wherein the fastener mechanism includes a clip, a hook and loop fastener, a disc having an adhesive layer, a clasp, a suction cup, a clamp, or a magnet.

7. The talking balloon according to claim 1, further including a second board secured to the wire, wherein the second board is placed facing opposite to the board.

8. The talking balloon according to claim 1, wherein the board includes a writable and erasable surface to allow a user to write and erase messages on the board.

9. A method of securing a talking balloon to a toy or display item, comprising
attaching a board to a first end of a wire;
attaching a fastener mechanism to a second of the wire;
applying a malleable adhesive putty to the fastener mechanism; and
securing the fastener mechanism to the toy or display item through the malleable adhesive putty.

10. The method according to claim 9, further including a blank sticker attached to the board.

11. The method according to claim 9, wherein the board has a shape resembling a cloud sphere having at least one protruding edge that extends outwardly.

12. The method according to claim 10, wherein the blank sticker includes several removable layers of paper to allow a user to rewrite and change messages.

13. The method according to claim 9, wherein the wire is made of flexible and bendable material.

14. The method according to claim 9, wherein the fastener mechanism includes a clip, a hook and loop fastener, a disc having an adhesive layer, a clasp, a suction cup, a clamp, or a magnet.

15. The method according to claim 9, further including a second board secured to the wire, wherein the second board is placed facing opposite to the board.

16. The method according to claim 9, wherein the board includes a writable and erasable surface to allow a user to write and erase messages on the board.
